(19) United States
(12) Patent Application Publication
(10) Pub. No.: US 2005/0096981 A1
(43) Pub. Date: May 5, 2005

(54) Visiting customer management system

(75) Inventor: Yoshiharu Shimada, Maebashi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/824,418

(22) Filed: Apr. 15, 2004

(30) Foreign Application Priority Data
Nov. 4, 2003 (JP) 2003-374620(PAT.

(51) Int. Cl. G06F 17/60

(52) U.S. Cl. 705/14

(57) ABSTRACT

When a customer visits a shop, a tag detector installed near the entrance of the shop senses a membership card carried by the customer, obtains the customer's member identification number, and records the customer's member identification number and an arrival time, at which the customer has visited the shop, in a visiting-customer information database. When the customer makes payment at a cash register that is a POS terminal, a customer master database is referenced in order to check if any other customer is a registered member of a group to which the customer belongs. If any other customer is a registered member of a group, the visiting-customer information database is referenced in order to check if the registered member has arrived at the shop in a predetermined time or less after the time at which the customer has arrived. If the customer has come with another member of the group, a reward is given to the customer.

### BACKGROUND OF THE INVENTION

1. Field of the Invention

The present invention relates to a visiting customer management system for managing visiting customers for the purpose of sales promotion. More particularly, the present invention is concerned with a visiting customer management system utilizing a reward point card.

2. Description of the Related Art

It is well known that a customer who the shops with any other member of a group to which he/she belongs, that is, with his/her friend or any other member of his/her family spends more than a customer who shops by himself/herself. At some shops, special promotional campaigns target children so as to encourage customers to come with their children or other family members. Proprietors want every customer to come with other member of a group to which he/she belongs (for example, with another member of his/her family) rather than by himself/herself, and thus want to increase the value of customer transactions without a promotional campaign. However, there is no effective means for encouraging customers to visit a shop with somebody else. Furthermore, such a promotional campaign cannot be run all the time.

A reward point system is a technique often adopted for sales promotion. According to the reward point system, customers of a shop or customers of franchised stores or a shopping center are provided with a card such as a magnetic card or an IC card. Every time a customer buys products for an amount of money equal to or higher than a predetermined amount of money, reward points are assigned to the card owner. Depending on the number of obtained points, a product or a service is provided for the customer. At shops at which they have introduced the reward point system, for example, they offer three times as many points as usual on a specific day in efforts to invite a larger number of customers. However, according to the ongoing point system, whether a customer shops by himself/herself, or with somebody else, cannot be distinguished.

In order to provide bonus points for a customer who comes with other member of a group to which he/she belongs, a customer may be requested to make an entry at a terminal on arrival at a shop so as declare that he/she has come with other member of the group. In this case, a customer must operate an entry terminal on arrival at a shop to declare that he/she has come with other member of the group (Japanese Unexamined Patent Publication No. 2002-133525).

### SUMMARY OF THE INVENTION

Accordingly, an object of the present invention is to provide a visiting customer management system capable of verifying, without bothering a customer, whether the customer has visited a shop with another member of a registered group. Herein, if the customer has come with other member of the group, the customer receives bonus points.

A visiting customer management system in accordance with the first aspect of the present invention comprises: a storage medium carried by a customer, in which at least customer identification information is stored; and a non-contact detector that detects, in a non-contact manner, the information stored in the storage medium and that is arranged at a shop. Moreover, at least the customer identification information and a group to which the customer belongs are stored in advance in a customer information storage device. The customer identification information detected by the non-contact detector is stored in association with a detection time, at which the customer identification information is detected, in a visiting-customer information storage device.

According to the first aspect of the present invention, when customer identification information on other customer belonging to the same group as the customer is stored in the visiting-customer information storage device, if the difference between a detection time at which the customer identification information on the customer is detected and a detection time at which the customer identification information on other customer is detected falls within a predetermined period of time, the customer is recognized to have come with another member of the group.

Moreover, according to the first aspect of the present invention, a terminal having a detector that detects customer identification information is included. When the detector included in the terminal detects customer identification information, whether a customer has come with other member of a group to which he/she belongs may be detected based on the customer identification information.

A visiting customer management system in accordance with a second aspect of the present invention comprises: a storage medium carried by a customer, in which at least customer identification information is stored, and a non-contact detector that detects in a non-contact manner the information stored in the storage medium and that is arranged in at a shop. Customer identification information and a group to which the customer belongs are stored in advance in a customer information storage device. A terminal includes a detector that detects customer identification information. The detector included in the terminal detects the customer identification information on the customer. The non-contact detector obtains customer identification information on other customers in the shop. If customer identification information on another member of the group to which the customer belongs corresponds to one of the pieces of customer identification information on other customers that are present in the shop, the customer is recognized to have come with another member of the group.

Moreover, according to the second aspect of the present invention, the non-contact detector is arranged so that it can simultaneously detect the pieces of customer identification information on all the customers that are present in the shop.

According to the present invention, visiting customers can be identified in a non-contact manner, and whether a customer has come with another member of a group to which he/she belongs can be judged without the necessity of bothering the customer. If a customer visits a shop with other member of a group to which he/she belongs, such as, other member of his/her family, the customer receives points. More and more customers are expected to visit a shop with other member of a group to which each customer belongs rather than by themselves. Eventually, customer transactions will increase and sales will grow.

### BRIEF DESCRIPTION OF THE DRAWINGS

The above and other objects of the present invention and the features and advantages thereof will be apparent from the following detailed description of the preferred embodiments of the invention in conjunction with the accompanying drawings, in which:

FIG. 1 schematically shows a customer management system in accordance with a first embodiment of the present invention;

FIG. 2 shows the face of a card employed in embodiments of the present invention;

FIG. 3 shows the back of the card employed in the embodiments of the present invention;

FIG. 4 shows an example of a customer master database employed in the embodiments of the present invention;

FIG. 5 shows an example of a visiting-customer information database employed in the embodiments of the present invention;

FIG. 6 shows an example of the configuration of a POS terminal employed in the embodiments of the present invention;

FIG. 7 describes part of a process to be executed in common in the embodiments of the present invention;

FIG. 8 describes part of a process to be executed in the first embodiment of the present invention;

FIG. 9 schematically shows a customer management system in accordance with a second embodiment of the present invention; and

FIG. 10 describes part of a process to be executed in the second embodiment of the present invention.

### DESCRIPTION OF THE PREFERRED EMBODIMENTS

As described previously, an object of the present invention is to manage customers while distinguishing customers who visit a shop by themselves from customers who visit the shop with another member of a group to which each customer belongs. According to a first embodiment, visit information is obtained in a non-contact manner from a card carried by a visiting customer in order to create a visiting-customer information database. Whether a customer has come as a member of a group is judged based on data recorded in the database.

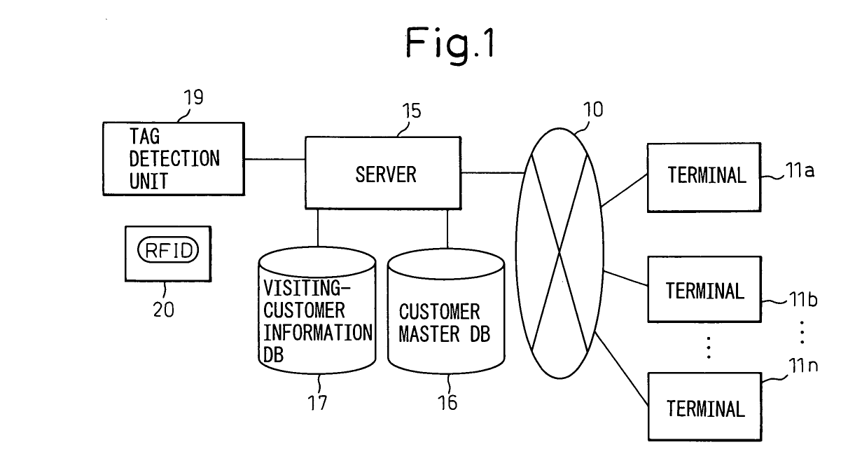

FIG. 1 schematically shows the first embodiment of a system in accordance with the present invention.

The system shown in FIG. 1 comprises a network 10 such as a LAN constructed within a certain shop. A plurality of payment terminals 11a to 11n installed as cash registers, such as, a plurality of point-of-sales (POS) terminals is connected on the network 10. Moreover, a server 15 to which a customer master database 16 and a visiting-customer information database 17 are connected is connected on the network 10. A tag detection unit 19 is connected to the server 15. The tag detection unit 19 is a non-contact detector that detects, in a non-contact manner, a radio-frequency identification (RFID) tag embedded in a card 20 carried by a customer.

The RFID tag falls into a type that utilizes electromagnetic waves, or more particularly, electromagnetic coupling or electromagnetic induction, a type that utilizes microwaves, a type that utilizes light and so on. The type of RFID tag utilizing electromagnetic waves comprises a complementary metal-oxide semiconducter (CMOS) chip that normally has an IC memory and a communication circuit, and a micro-antenna. Moreover, the RFID tag can be a type having a power supply incorporated therein or a type not having a power supply. The present embodiment adopts the type of RFID tag that has no power supply. In this case, the non-contact detector induces power in the RFID tag by radio, and uses the power to read information from the RFID tag by radio. According to the present embodiment, the tag detection unit 19 reads a signal sent from the RFID tag in a non-contact manner so as to obtain a customer number that is customer identification information. Preferably, the tag detection unit 19 can detect the RFID tag in a card, which is carried by a customer, without the necessity of asking the customer to show his/her card. The tag detection unit 19 may be connected on the network 10.

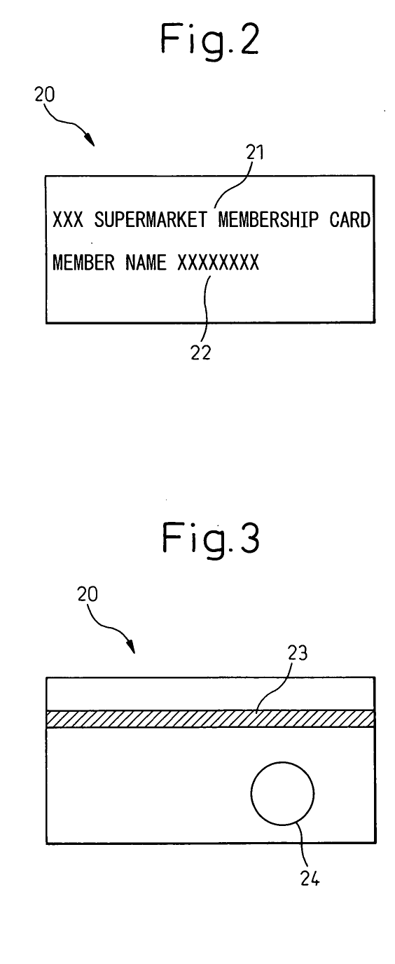

The tag such as the RFID tag is embedded in a membership card 20 given to a customer or a member whose name is registered at the shop. The membership card 20 has the face shown in FIG. 2 and the back shown in FIG. 3. On the face, like conventional cards, a shop name 21 and a member name 22 that is the name of a card owner are inscribed. The back has a conventional magnetic stripe 23 in which a member identification (ID) number with which the card owner is identified is recorded. Moreover, an RFID tag 24 in which the same member ID number as the one recorded in the magnetic stripe is recorded is embedded in the back. Other various pieces of information can be recorded in the RFID tag. Alternatively, another IC memory may be adopted. In the present embodiment, the magnetic stripe is adopted so that the membership card can be treated by conventional types of POS terminals. If POS terminals are designed to read the RFID tag, the magnetic stripe may be excluded. Moreover, the RFID tag may be embedded in anything rather than the card as long as each customer can be identified. According to the present embodiment, other members of a member's family are also registered as members, and the membership card having the RFID tag, in which the member ID number is recorded, embedded therein is distributed to the family members in advance. One family is managed as one group. The RFID tag may not be employed but a card having a power supply may be adopted.

The tag detection unit 19 is disposed near the entrance of the shop so that it can detect a visiting customer. However, the position of the tag detection unit 19 is not limited to the entrance of the shop but may be any place as long as it can detect that a customer and his/her family have entered the shop. For example, the tag detection unit 19 may be arranged on a corridor in a shop through which customers pass without fail.

The customer master database is a database for use in managing customers who have their membership cards created and who are registered as members. At least a member name and a member ID number are recorded in the customer master database. Furthermore, if a customer belongs to a predetermined group, the information on the group is recorded in the customer master database. If a reward point system in which reward points are assigned to a customer according to an amount of money paid for products using the card is adopted (a privilege is given depending on the amount of points), the amount of points is recorded in the master database.

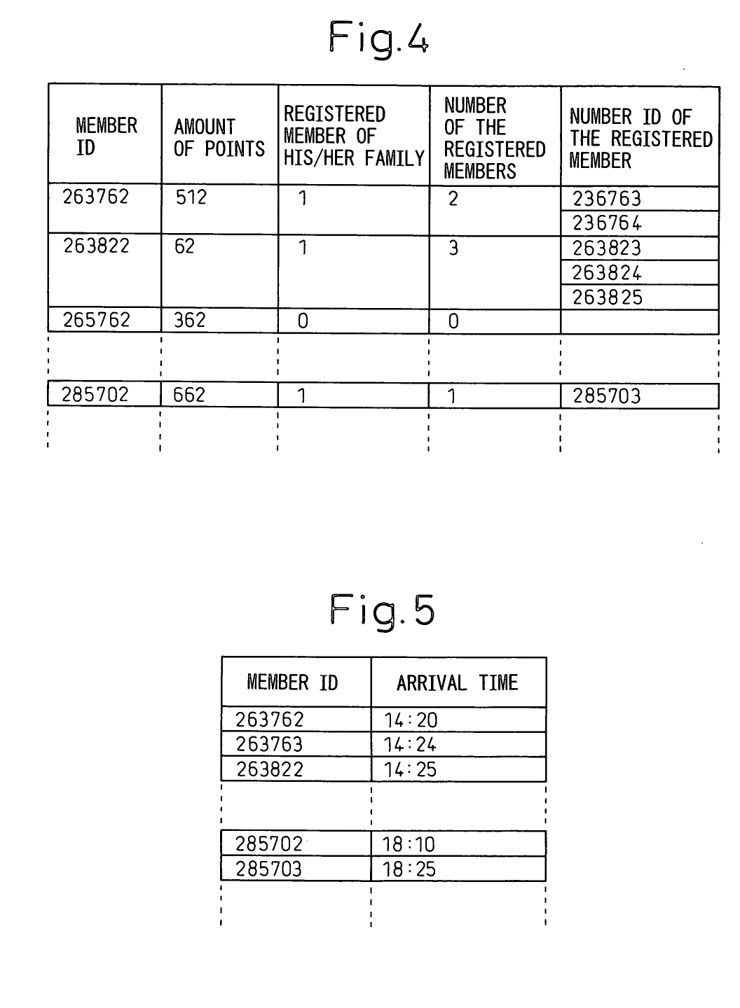

FIG. 4 shows an example of the customer master database. In the database, the amount of points, whether other member of the customer's family is registered (1 signifies that other member of the customer's family is registered, and 0 signifies that any other member of the customer's family is not registered), the number of registered members of his/her family, and the registered member ID numbers are recorded in association with a member ID number. For example, assuming that a customer has a member ID number of 263762, the total of points is 512. Moreover, since 1 is specified in the column “registerd member of his/her family,” any other member of the customer's family is registered. The number of the registered members is 2, and the registered member ID numbers are 236783 and 23664.

Herein, one group is one family. Alternatively, one group may be a group of friends, neighborhood housewives, or colleagues. Whether a group is acknowledged depends on each shop or the like.

FIG. 5 shows an example of data recorded in the visiting-customer information database. As visiting-customer information, a member ID number and an arrival time are stored in a table. The arrival time is the time when the non-contact detector (tag detection unit) 19 arranged at the entrance of a shop is activated to detect a signal from a RFID tag carried by a visiting customer.

The customer master database and visiting-customer information database are shown in FIG. 1 to be directly connected to the server. Alternatively, the databases may be connected to the server over the network 10.

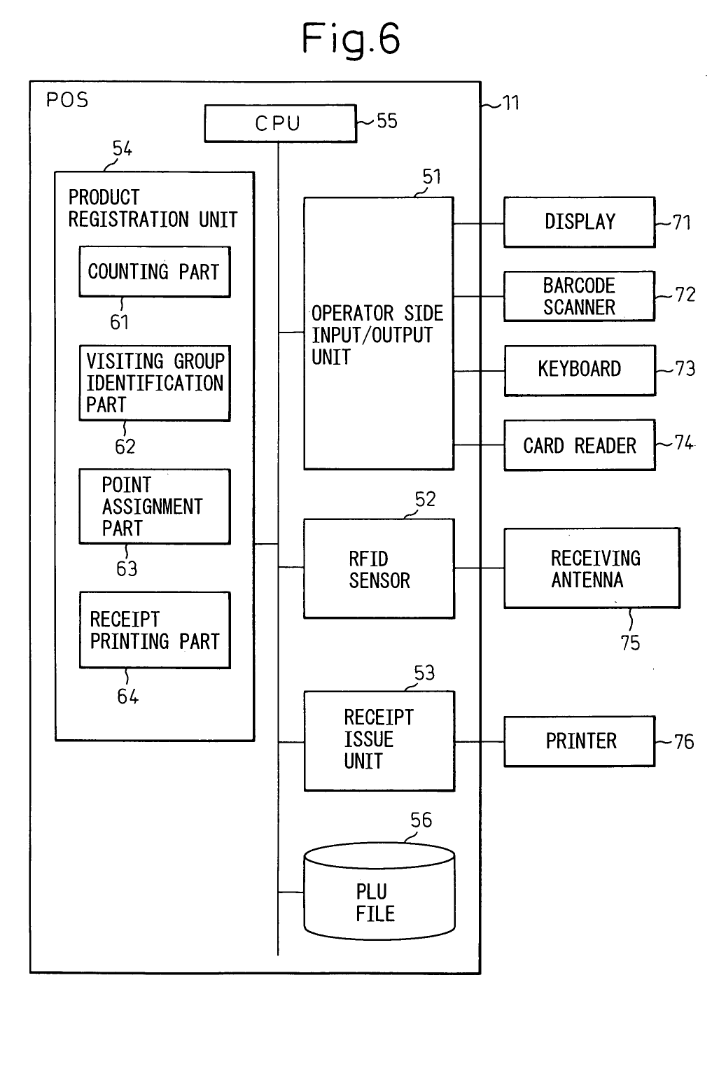

FIG. 6 shows an example of the configuration of a POS terminal employed in the present embodiment.

A central processing unit (CPU) 55 manages and controls the whole of the POS terminal 11. For example, an operator-side input/output unit 51 controls the input/output operations performed by an operator of a POS terminal disposed as, for example, a cash register in a shop. A display 71, a barcode scanner 72, a keyboard 73, and a card reader 74 are connected to the operator-side input/output unit 51. If a barcode is inscribed on a product, the operator uses the barcode scanner 72 to scan the barcode so as to read the price. If the barcode is not readable or no barcode is inscribed, the operator uses the keyboard 73 to enter the price. The entered prices and the sum total are presented on the display 71. The card reader 74 is used to read a customer's membership card so as to acquire the member ID number. According to the present embodiment, the POS terminal 11 includes an RFID sensor. Therefore, the customer's member ID number can be acquired without the necessity of passing the membership card 20 through the card reader 74.

Moreover, the POS terminal 11 has a printer 76, such as, a thermal printer connected to a receipt issuance unit 53. A receipt in which the breakdown of a payment and a sum total are printed is issued via the printer 76. The number of points is also printed in the receipt, if any.

In the POS terminal 11, a product registration unit 54 controls data received from the operator-side input/output unit 51 for issuing a receit and also controls data received from an RFID sensor 52 if necessary. Thereafter, the receipt issue unit 53 issues the receipt. The product registration unit 54 includes an counting part 61, a visiting group identification part 62, a point assignment part 63, and a receipt printing part 64. The counting part 61 calculates an amount of payment for products a customer has bought, a consumption tax, and others. The visiting group identification part 62 verifies whether a customer has come with other member of a predetermined group such as a family. The point assignment part 63 assigns points to the customer according to, for example, the amount of payment. Moreover, if the customer has come with other member of a group to which he/she belongs, bonus points are assigned to the customer. The receipt printing block 64 has stored product names, prices, and product numbers in a memory, and controls the receipt issue unit 53 so that these data items will be printed in a receipt.

Furthermore, the POS terminal 11 employed in the present embodiment has a price look-up (PLU) file 56 in which product names and selling prices are recorded. The PLU file 56 provides the counting part 61 with the prices of products a customer has purchased.

According to the present embodiment, the visiting group identification part 62 and point assignment part 63 are included in each terminal 11. Alternatively, they may be included in the server that is a host computer. The PLU file 56 may be included in the server, and the server may be queried about a price. Whether a data processing function in the system is provided in a server or a terminal can be decided by a person with ordinary skill in the art.

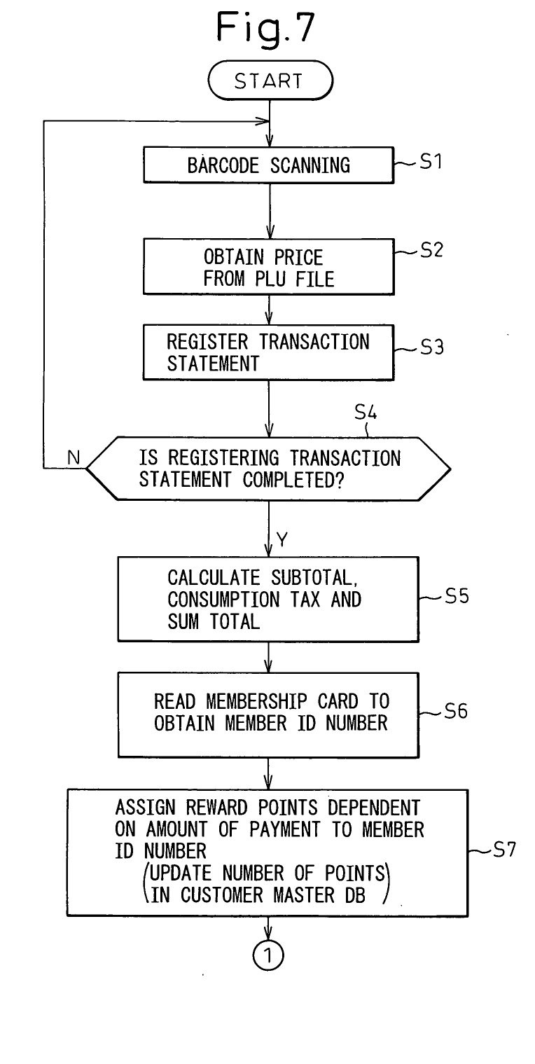

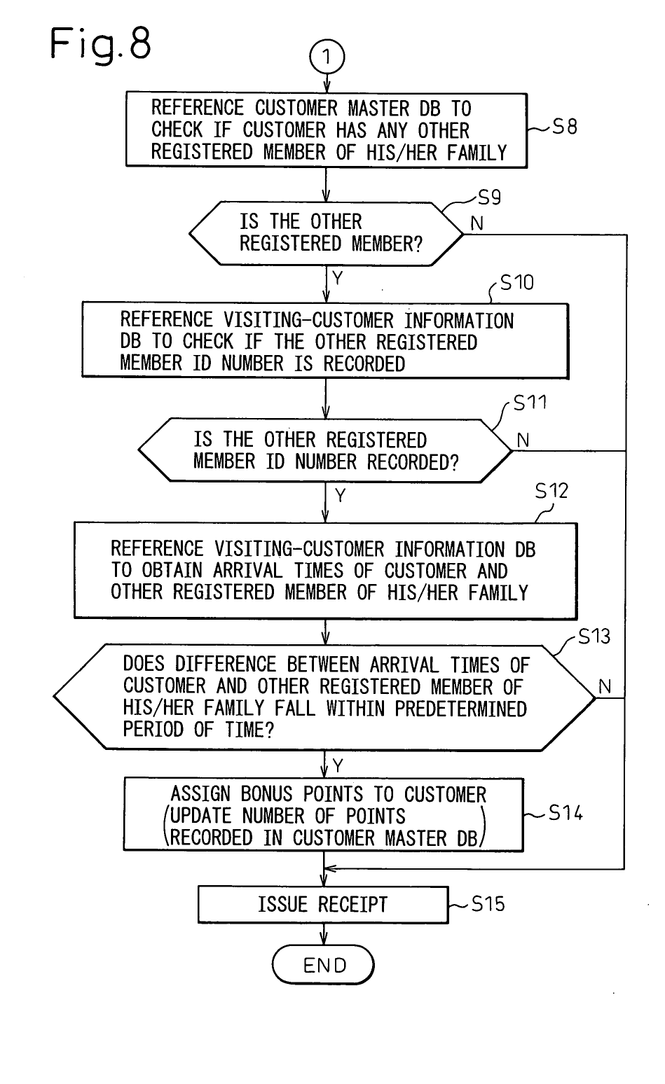

Next, referring to FIG. 7 and FIG. 8, a process to be executed in the embodiment of the present invention will be described below.

After a customer finishes doing the shopping at a shop, when the customer makes payment at a cash register, the process starts.

At step S1, the barcode reader included in the POS terminal 19 installed at the cash register is used to read a barcode inscribed on a product. At step S2, the PLU file 56 is referenced based on the read barcode in order to acquire price information on the product. At step S3, a transaction statement about the purchased product is registered, and process proceeds to step S4. At step S4, if there are other products, control is returned to step S1. The barcode on the next product is scanned. If the transaction statements of all purchased products are registered, process proceeds to step S5. A Subtotal key is then pressed, whereby a subtotal, a consumption tax, and a sum total are calculated.

Thereafter, at step S6, the customer is asked to present his/her membership card. The membership card is passed through the card reader 74 and thus scanned in order to acquire a member ID number that is member identification information on the customer. The acquisition of a member ID number from a membership card at step S6 may be performed before the barcode on each product is scanned at step S1 or may be performed during the calculation of step S5. At step S7, the number of reward points dependent on an amount of payment is assigned to the acquired member ID number. Specifically, the number of points recorded in the customer master database is updated. Herein, in order to acquire a member ID number, a membership card is passed through the card reader, and information is read from the magnetic stripe on the membership card. Alternatively, as a receiving antenna 75 designed to read a radio-frequency identifier (RFID) tag is placed near a cash register, a member ID number may be read from an RFID tag. In this case, a customer need not present his/her membership card but his/her member ID number can be read.

Thereafter, at step S8 in FIG. 8, the customer master database 16 is referenced based on the acquired member ID number in order to check if the customer has any other registered member of his/her family. If it is judged at step S9 that the customer does not have any other registered member of his/her family, process proceeds to step S15. A receipt is issued in exchange for payment, and the process is terminated. The amount of assigned points is printed together with a purchase specification in the receipt.

If it is judged at step S9 that the customer has any other registered member of his/her family, the visiting-customer information database 17 is referenced based on the member ID number of the familial member at step S10. At step S11, it is judged whether the member ID number of the other registered member is recorded. If the member ID number is not recorded, it means that the customer has come by himself/herself. Process then proceeds to step S15. A receipt is then issued in exchange for payment, and the process is terminated.

In contrast, if it is judged at step S11 that the member ID number of the other registered member is recorded in the visiting-customer information database 17, the arrival time at which the customer and the other registered member have come are retrieved from the visiting-customer information database 17 at step S12. Thereafter, at step S13, the arrival time of the customer is compared with the arrival time of the other registered member. It is then judged whether the difference between the arrival time falls within a predetermined period, for example, ten minutes. If the difference is equal to or larger than the predetermined period, it is judged that the customer and the other registered member have come mutually independently. Process then proceeds to step S15. A receipt is issued in exchange for payment and the process is terminated.

If it is judged at step S13 that the difference between the arrival time of the customer and the arrival time of the other registered member falls within the predetermined period, it is judged that the customer and the other registered member have come in a group. Bonus points are assigned to the customer. Namely, the number of points recorded in the customer master database is updated. Thereafter, at step S15, a receipt is issued in exchange for payment and the process is terminated. The number of bonus points is printed in addition to the number of normal points.

According to the present embodiment, each terminal 11 judges whether a customer has come with another member of his/her family. Alternatively, part or the whole of the step of making the judgment may be performed by the server 15 that is a host computer. For example, after it is judged at step S9 that a customer has other registered member of his/her family, the POS terminal 11 may query the server 15 whether the customer has come with other member of his/her family, and the server 15 may respond to the query. Specifically, the POS terminal 11 queries the server 15 whether a member ID number assigned to other member of a group to which the customer belongs is recorded in the visiting-customer information database 17. If the server 15 responds that the member ID number is recorded, the POS terminal 11 queries the server 15 whether the difference between the arrival time of the customer and the arrival time of the other registered member falls within the predetermined period of time.

Moreover, the POS terminal 11 may merely notify the server 15, which is a host computer, of a member ID number. In response to the notification, the server 15 may judge whether the customer has other registered member of his/her family and whether the customer has come with the other registered member. The server 15 may then return the result of the judgment to the POS terminal 11. Specifically, the server 15 reads a member ID number, which is assigned to other member of the customer's family, from the customer master database 16, and judges whether a number corresponding to the member ID number assigned to the other registered member is recorded in the visiting-customer information database 17. Moreover, the server 15 judges whether the difference between the arrival time of the customer and the arrival time of the other registered member falls within the predetermined period of time. If the difference falls within the predetermined period of time, the server 15 notifies the POS terminal 11 that the customer has come with other member of a group to which he/she belongs. Thus, a person with ordinary skill in the art can determine the job assignments of the host computer and terminal on the basis of a system design.

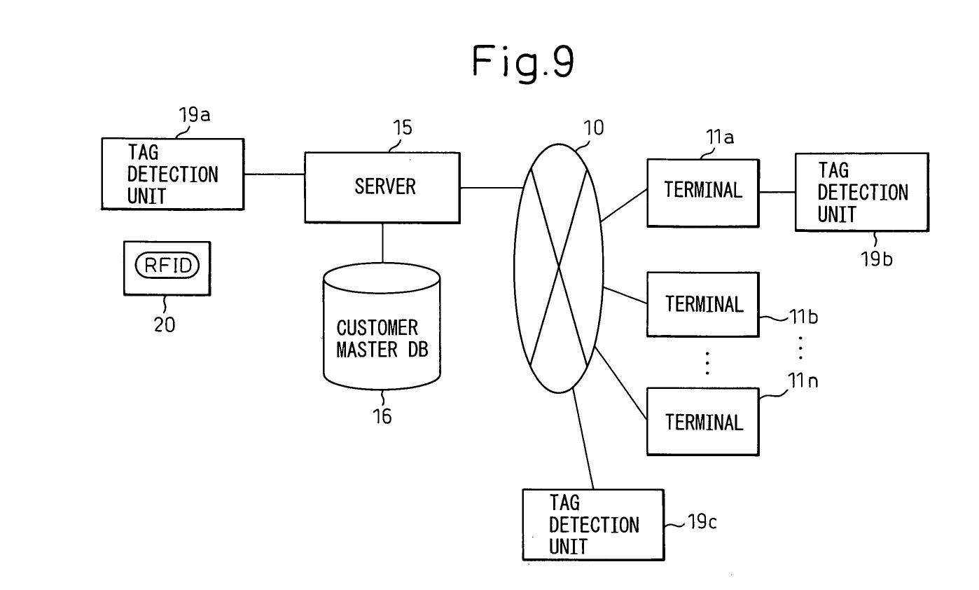

FIG. 9 schematically shows a second embodiment of the present invention.

The same reference numerals are assigned to members identical to those shown in FIG. 1. Differences from the first embodiment lie in that the visiting-customer information database 17 (FIG. 1) is not needed and that tag detection units 19a to 19c are arranged at different places within a shop so that signals from RFID tags carried by all customers in the shop can be obtained concurrently. Incidentally, the tag detection unit 19b connected to the terminal 11a may be replaced with the radio-wave receiving antenna 74 shown in FIG. 6. Needless to say, other tag detection units may be connected to the other terminals 11b to 11n.

According to the second embodiment, the visiting-customer information database 17 is not created. When a customer makes payment at the POS terminal 11, it is sensed whether any other registered member of the customer's family is in a shop. If other registered member is there, it is judged that the customer has come with other member of a group to which he/she belongs.

To be more specific, when a customer makes payment at any of the POS terminal 11a to 11b serving as cash registers, the POS terminal is used to obtain the customer's member ID number and assign points determined with an amount of money for which the customer has bought products. Thereafter, the customer master database 16 is referenced in order to check if the customer has any other registered member of his/her family. If the customer has the other registered member of his/her family, radio waves radiated from the RFID tags embedded in the respective membership cards 20 present in the shop are sensed in order to obtain member ID numbers. It is then checked whether the member ID number assigned to the customer's family member is included in the obtained member ID numbers. If the member ID number of the customer's family member is included in the obtained member ID numbers, it is judged that the customer has come with other member of a group to which he/she belongs, and reward points are assigned to the customer.

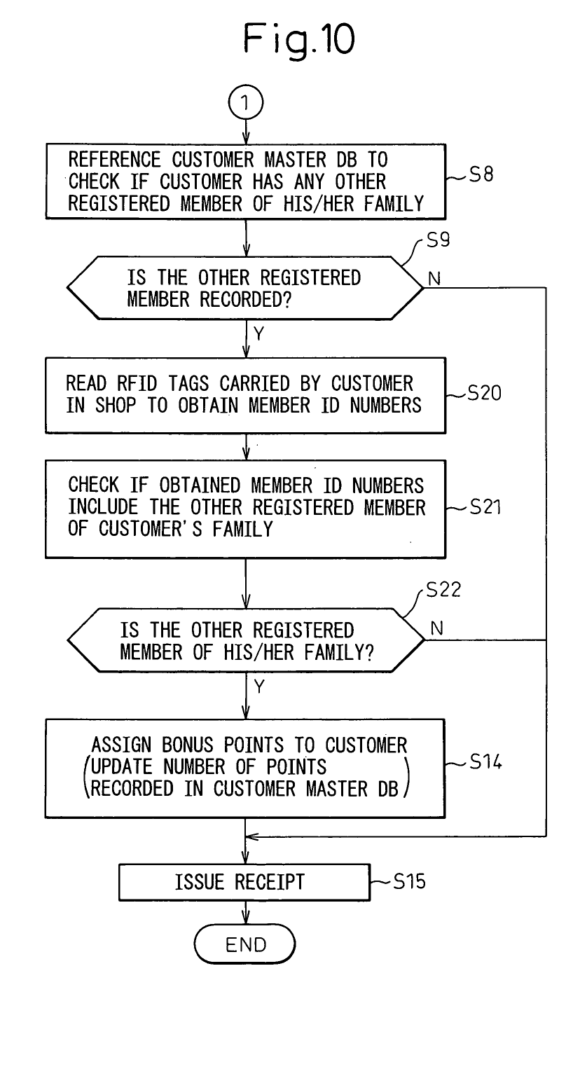

FIG. 7 and FIG. 10 describe a process to be executed in the second embodiment of the present invention. Even in the second embodiment of the present invention, similarly to the first embodiment, when a customer makes payment at a cash register, it is judged whether the customer has come with any other member of a group to which he/she belongs. Therefore, the POS terminal is used to calculate an amount of payment for products purchased and to assign reward points in the same manner as described in FIG. 7.

According to the second embodiment of the present invention, when the steps described in FIG. 7 are completed, the process proceeds to a step described in FIG. 10. The same reference numerals are assigned to steps in FIG. 10 identical to those employed in the first embodiment (FIG. 8).

At step S8 in FIG. 10, similarly to the first embodiment, after normal points are assigned, the customer master database is referenced based on an obtained member ID number in order to check if a customer has any other registered member of his/her family. If it is judged at step S9 that the customer has no other registered member of his/her family, the process proceeds to step S15. A receipt is issued and the process is terminated.

If it is judged at step S9 that the customer has any other registered member of his/her family, the process proceeds to step S20. In the present embodiment, the plurality of non-contact detectors, that is, tag detection units 19a to 19c is disposed in order to sense the RFID tags embedded in the respective membership cards carried by all the customers in a shop. At step S20, the non-contact detectors are all actuated in order to obtain the member ID numbers of all the customers in the shop. If a shop has a large floor space or has a plurality of floors, a floor on which the non-contact detectors are actuated may be limited to a floor on which, for example, cash registers are disposed. Otherwise, the non-contact detectors may be installed near a section of a floor in which cash registers are disposed. Generally, while a customer is making payment, other member of the customer's family is often waiting for the customer near the cash register. Therefore, the non-contact detector to be actuated may be limited to the tag detection unit 19b located near the cash register in order to obtain member ID numbers near the cash register alone.

At step S21, it is checked if the obtained member ID numbers include the member ID number of other member of the customer's family. If it is judged at step S22 that the obtained member ID numbers do not include the member ID number of other member of the customer's family, process proceeds to step S15. A receipt is issued in exchange for payment. In contrast, if the obtained member ID numbers include the member ID number of other member of the customer's family, the customer is recognized to have come with other registered member of a group, to which the customer belongs. The process then proceeds to step S14.

At step S14, bonus points are assigned to the customer, that is, the number of points recorded in the customer master database is updated. Thereafter, the process proceeds to step S15. A receipt is issued in exchange for payment and the process is terminated. The number of normal points and the number of bonus points are printed in the receipt.

Even in the second embodiment, the job of checking whether a customer has come with other member of his/her family can be shared by the POS terminal 11 and the server 15 that is a host computer. Namely, after a member ID number is obtained at step S6, the POS terminal 11 queries the server 15 on the basis of the member ID number. The server 15 references the customer master database to retrieve a member ID number, which is assigned to another member of the customer's family, from the customer master database on the basis of the member ID number, and notifies the POS terminal of the retrieved member ID number. The POS terminal judges whether member ID numbers obtained by the non-contact detectors include the corresponding member ID number.

Moreover, the POS terminal 11 may merely notify the server 15 of the member ID number of the customer, and the server 15 may judge whether the customer has come with other member of his/her family and may then return the result of the judgment to the POS terminal. Specifically, the server 15 is notified of the member ID number of a customer scanned by the POS terminal 11 and the member ID numbers of all customers being in a shop which are obtained by the non-contact detectors, that is, the tag detection units 19. The server 15 then references the customer master database 16 on the basis of the customer's member ID number so as to retrieve a member ID number assigned to other member of the customer's family. The server 15 then judges whether the member ID numbers of all the customers being in the shop include a member ID number of the other registered member of his/her family.

According to the first and second embodiments, if at least another registered member of a customer's family meets the conditions, it is judged that the customer has come with the other member of a group to which he/she belongs. A certain bonus points are assigned to the customer. Alternatively, the number of the other registered members in a shop may be calculated. If the calculated number of the registered members is large, the number or rate of bonus points may be increased. Moreover, the number or rate of bonus points may depend on an amount of payment.

Furthermore, the first and second embodiments have been described on the assumption that the POS terminal and the reward point system are employed. The present invention is not limited to the employment of the POS terminal and the reward point system. Even at a shop at which they do not adopt the reward point system, a service for rewarding a customer who comes with other member of a group to which he/she belongs can be provided.

1. A visiting customer management system including a storage medium carried by a customer, in which at least customer identification information is stored, and a non-contact detector that detects in a non-contact manner the information stored in said storage medium and that is arranged in a shop, comprising:
a customer information storage device in which at least the customer identification information and a group to which said customer belongs are stored in advance; and
a visiting-customer information storage device in which customer identification information detected by said non-contact detector is stored in association with a detection time at which the customer identification information is obtained.

2. A visiting customer management system according to claim 1, wherein said storage medium is a radio-frequency identification (RFID) tag.

3. A visiting customer management system according to claim 1, wherein: customer identification information on other customer who belongs to the same group as said customer is stored in said visiting-customer information storage device; and if the difference between a detection time at which the customer identification information on said customer is detected and a detection time at which the customer identification information on other customer is detected falls within a predetermined period of time, said customer is recognized to have come with another member of the group.

4. A visiting customer management system according to claim 3, wherein if said customer is recognized to have come with another member of the group, a reward is given to said customer.

5. A visiting customer management system according to claim 1, further comprising a terminal that includes a detector which detects customer identification information, wherein: when said detector included in said terminal detects customer identification information, customer identification information on other customer who belongs to the same group as said customer is read from said customer information storage device; and when the customer identification information on other customer who belongs to the same group as said customer is stored in said visiting-customer information storage device, if the difference between a detection time at which the customer identification information is detected and a detection time at which the customer identification information on other customer is detected falls within a predetermined period of time, said customer is recognized to have come with another member of the group.

6. A visiting customer management system according to claim 5, wherein said terminal is a POS terminal.

7. A visiting customer management system according to claim 1, further comprising a terminal that includes a detector which detects customer identification information, and a host computer that judges whether a customer has come with other member of a group to which he/she belongs, wherein:
when said detector included in said terminal detects customer identification information, said terminal reads customer identification information on other customer, who belongs to the same group as said customer, from said customer information storage device, and notifies said host computer of the read customer identification information; and
when the customer identification information on other customer who belongs to the same group as said customer is stored in said visiting-customer information storage device, if the difference between a detection time at which the customer identification information on said customer is detected and a detection time at which the customer identification information on other customer is detected falls within a predetermined period of time, said host computer judges that said customer has come with another member of the group.

8. A visiting customer management system according to claim 1, further comprising a terminal that includes a detector which detects customer identification information, and a host computer that judges whether a customer has come with other member of a group to which he/she belongs, wherein:
when said detector included in said terminal detects customer identification information, said terminal notifies said host computer of the customer identification information;
said host computer reads customer identification information on another customer, who belongs to the same group as said customer, from said customer information storage device; and
when the other customer identification information on another customer who belongs to the same group as said customer is stored in said visiting-customer information storage device, if the difference between a detection time at which the customer identification information on said customer is detected and a detection time at which the customer identification information on other customer is detected falls within a predetermined period of time, said host computer judges that said customer has come with another member of the group.

9. A visiting customer management system including a storage medium carried by a customer, in which at least customer identification information is stored, and a non-contact detector that detects in a non-contact manner the information stored in said storage medium and that is arranged in a shop, comprising:
a customer information storage device in which the customer identification information and a group to which said customer belongs are stored in advance; and
a terminal including a detector that detects customer identification information, wherein:
said detector included in said terminal detects the customer identification information on said customer;
said non-contact detector obtains customer identification information on other customers that are present in said shop;
when customer identification information on other member of the group to which said customer belongs corresponds to one of the pieces of customer identification information on other customers that are present in said shop, said customer is recognized to have come with another member of the group.

10. A visiting customer management system according to claim 9, wherein said storage medium is an RFID tag.

11. A visiting customer management system according to claim 9, wherein said terminal is a POS terminal.

12. A visiting customer management system according to claim 9, wherein said non-contact detector is arranged so that it can simultaneously detect the pieces of customer identification information on all the customers that are present in said shop.

13. A visiting customer management system according to claim 9, wherein when said customer is recognized to have come with other member of the group, a reward is given to said customer.

14. A visiting customer management system including a storage medium carried by a customer, in which at least customer identification information is stored, and a non-contact detector that detects in a non-contact manner the information stored in said storage device and that is arranged in a shop, comprising:
a customer information storage device in which the customer identification information and a group to which said customer belongs are stored in advance;
a terminal including a detector that detects customer identification information; and
a host computer, wherein:
when said detector included in said terminal detects the customer identification information on said customer, said terminal notifies said host computer of the detected customer identification information;
said host computer obtains customer identification information on other customer, who belongs to the same group as said customer, from said customer information storage device, and notifies said terminal of the customer identification information on other customer; and
if one of pieces of customer identification information on other customers that are present in said shop corresponds to the customer identification information on other member who belongs to the same group as said customer, said terminal judges that said customer has come with other member of the group.

15. A visiting customer management system according to claim 14, wherein said storage medium is an RFID tag.

16. A visiting customer management system according to claim 14, wherein said terminal is a POS terminal.

17. A visiting customer management system according to claim 14, wherein said non-contact detector is arranged so that it can simultaneously detect the pieces of customer identification information on all the customers in said shop.

18. A visiting customer management system according to claim 14, wherein when said customer is recognized to have come with other member of the group, a reward is given to said customer.

19. A visiting customer management system including a storage medium carried by a customer, in which at least customer identification information is stored, and a non-contact detector that detects, in a non-contact manner, the information stored in said storage device and that is arranged in a shop, comprising:
a customer information storage device in which the customer identification information and a group to which said customer belongs are stored in advance;
a terminal including a detector that detects customer identification information; and
a host computer, wherein:
said detector included in said terminal detects the customer identification information on said customer;
said non-contact detector detects pieces of customer identification information on other customers that are present in said shop;
said host computer is notified of the detected customer identification information and the detected pieces of customer identification information on other customers that are present in said shop; and
if customer identification information on other member of the group to which said customer belongs corresponds to one of the pieces of customer identification information on other customers that are present in said shop, said host computer judges that said customer has come with another member of the group and notifies said terminal of the result of the judgment.

20. A visiting customer management system according to claim 19, wherein said storage medium is an RFID tag.

21. A visiting customer management system according to claim 19, wherein said terminal is a POS terminal.

22. A visiting customer management system according to claim 19, wherein said non-contact detector is arranged so that it can simultaneously detect the customer identification information of all the customers in said shop.

23. A visiting customer management system according to claim 19, wherein when said customer is recognized to have come with other member of the group, a reward is given to said customer.
